(19) United States
(12) Patent Application Publication
(10) Pub. No.: US 2024/0326385 A1
(43) Pub. Date: Oct. 3, 2024

(54) METHOD FOR PRODUCING ILLUMINATED LAMINATED GLAZING, WHICH IS TRANSPARENT IN A NON-ILLUMINATED STATE

(71) Applicant: SAINT-GOBAIN GLASS FRANCE, COURBEVOIE (FR)

(72) Inventors: Florian FLAMARY MESPOULIE, COMPIEGNE (FR); Leila DUMOTIER, MARGNY LES COMPIEGNE (FR); Sophie Marie BARAT, SAINT AUBIN (FR); François COMPOINT, SAINT-PIERRE DES CORPS (FR)

(21) Appl. No.: 18/576,661

(22) PCT Filed: Jun. 16, 2022
(86) PCT No.: PCT/FR2022/051170

§ 371 Date: Jan. 4, 2024

(30) Foreign Application Priority Data
Jul. 15, 2021 (FR) FR2107648

(51) Int. Cl. B32B 17/10; B32B 1/00; B32B 38/00

(52) U.S. Cl. CPC B32B 17/10036; B32B 1/00; B32B 17/10266; B32B 17/10339; B32B 17/10541; B32B 17/10577; B32B 17/1077; B32B 17/10788; B32B 38/145; B32B 2038/0076; B32B 2264/102; B32B 2264/30; B32B 2264/305; B32B 2307/75; B32B 2310/0831; B32B 2315/08; B32B 2329/06; B32B 2331/04; B32B 2375/00

(57) ABSTRACT

A method of making a laminated glazing including at least two glass sheets bonded to each other by an adhesive interlayer, the method including, prior to assembling the laminated glazing, digital printing of one face, intended to be inside the laminated glazing, of at least one of the two glass sheets after their possible forming/bending, and/or of at least one face of the adhesive interlayer, by a homogeneous organic ink with a viscosity between 1 and 50 mPa·s including 50 to 99% by weight of ultraviolet-curable resin and 0.05 to 20% by weight of scattering particles, and then curing the organic ink under illumination with ultraviolet radiation.

This invention relates to illuminating glazings according to different known light emission methods, in designs of any complexity, in different colors, among others. There is a demand for this type of glazing in the automotive industry, for example for glass roofs.

One could consider printing a light-scattering (mineral) enamel on the glass before bending, or printing a scattering ink on the adhesive interlayer before assembling the laminated glazing. The printed designs thus obtained are then illuminated by activating an edge lighting of the glazing, which can consist of a light-emitting diode (LED) bar arranged on the edges of the glazing, or a circular LED arranged in a hole provided in the illuminating glazing.

One of the drawbacks of these technologies is that the printed scattering designs are visible to the passengers of the car, whether the glazing lighting is activated or not. Indeed, the printed materials can be colored or translucent for example. Thus, even without on-board lighting (switched off or missing), the printed designs are visible from inside the vehicle and can obstruct visibility through the glazing. This effect can be reduced by printing very fine designs, but this greatly limits the flexibility of these designs. The invention aims to solve this problem by providing a method for obtaining a light extraction solution that is transparent in the unlit state.

In a first way, it can be envisaged to print a mineral material. Transparent mineral pastes requiring heat treatment between 55° and 800° C., deposited before glass forming, are not compatible with bending techniques, as they exhibit a sticky behavior during processing. They cannot withstand contact with the tooling or the paired counter glass (different glass sheets in a laminated glazing are frequently curved, in a known way, by gravity sagging, in intimate contact with each other). The techniques to make these pastes non-sticky make them lose their transparency.

The positioning of these mineral materials on the face of a glass sheet intended to constitute the main internal face of the laminated glazing, not requiring the materials to be non-sticky, is not acceptable because transparent enamels have a low resistance to aging, and this positioning is not appreciated by consumers. (The main internal face of the laminated glazing is relative to the volume delimited by the laminated glazing, particularly the passenger compartment of a motor vehicle).

In a second way, organic ink printing seems to be the most promising solution to make a light-extracting coating that is transparent. This ink is printed on the adhesive interlayer because, due to its organic nature, it does not withstand the glass-forming temperature of over 500° C. Common solvent-based polyvinyl butyral (PVB) inks require a lengthy drying process when printed on PVB, as this polymeric substrate is incompatible with infrared (IR) drying.

The purpose of the invention is to provide a method for producing such designs, which are invisible when the lighting is switched off, without the aforementioned disadvantages. For this purpose, the invention has as its object a method of making a laminated glazing comprising at least two glass sheets bonded to each other by an adhesive interlayer, characterized in that it comprises, prior to the assembly of the laminated glazing, digital printing of one face intended to be inside the laminated structure, of at least one of the two glass sheets after their possible forming/bending, and/or of at least one face of the adhesive interlayer, by means of a homogeneous organic ink with a viscosity between 1 and 50 mPa·s comprising 50 to 99% by weight of ultraviolet-curable resin and 0.05 to 20% by weight of scattering particles, and then curing the organic ink under illumination with ultraviolet radiation.

According to the invention, a light-scattering, transparent UV-curable (or cross-linkable) ink is deposited by a digital printing method. A digital printing technique (direct printing on the substrate) makes it possible to print the ink without any contact with the substrate to be printed. The adhesive interlayer and/or an inner face of the laminated structure of a curved glass sheet (after the forming process) are printed.

An UV-curable resin is a composition of uncrosslinked monomers and/or oligomers, in an intermediate state of reaction/polymerization, and optionally one or more UV curing initiators.

Ink drying is fast (UV curing), compatible with the cycle times required on automotive laminated glazing production lines. This drying process is no longer the bottleneck of assembling the laminated glazing. The adhesion to the glass is good. No primer is required.

Preferably, the adhesive interlayer is made of polyvinyl butyral (PVB), thermoplastic polyurethane (TPU), or an ethylene vinyl acetate copolymer (EVA), or an ionomer. An example of a monomer resin is marketed by Kuraray Company under the registered trademark SentryGlas®.

Preferably, the ink contains 0.01 to 20% by weight of one or more rheology modifiers.

Preferably, the ink contains 0.1 to 20% by weight of 1 to 20% by weight of thermoplastic polymer material in one or more organic solvents. The thermoplastic material can be selected from polyvinyl butyral (PVB), thermoplastic polyurethane (TPU), ethylene-vinyl acetate copolymer (EVA), or an ionomer, alone or in a mixture or copolymer of several of them. The thermoplastic polymer material may contain 5 to 45% by weight of plasticizer. A benzoate ester, a phthalate and/or its derivative, an adipate and/or its derivative, a fatty acid ester, a trioctyltrimellitate, a triacetin, a glycerol, a propylene glycol, a sorbitol or a trimethylpentanedioldiisobutyrate, alone or in a mixture of several of them, are examples of plasticizers.

Preferably, the scattering particles have a particle size defined by D90 less than 2 μm, preferably between 100 and 700 nm, especially around 400 nm.

Preferably, the scattering particles are selected from among non-luminescent particles of TiO₂, SiO₂, CaCO₃, ZnO, Al₂O₃, ZrO₂.

In one particular embodiment of interest, the organic ink comprises at most 5% by weight of luminescent particles, selected from luminophores, fast-decay fluorescent particles, or molecules coating non-luminescent particles. The luminescent particles are dispersed in the polymer matrix. The durability of these luminescent particles to light radiation must be high in order not to lead to an accelerated decay of the initial properties. An example is the product marketed by BASF under the registered trademark TINOPAL® OB CO.

Preferably, the ultraviolet-curable resin is selected from a reaction product between a thiol and an alkene (called thiol-ene), an acrylate such as epoxy-acrylate, polyester-acrylate, urethane-acrylate, silicone-acrylate alone or as a mixture of several of them.

Preferably, prior to the assembly of the laminated glazing, the adhesive interlayer has a roughness Rz between 5 and 25, preferably 10 and 15 μm.

According to a first embodiment, the ink is directly printed on the adhesive interlayer by single or multi-pass inkjet printing.

According to a second embodiment, the ink is directly printed on a curved glass sheet by single or multi-pass inkjet printing. In this case, three variants are possible. In accordance with the former, the printheads are mounted on a multi-axis robot and the glass sheet is fixed. In the second one, contrariwise, the curved glass sheet is held by a multi-axis robot under the stationary printheads. In the third one, there is both a movement of the substrate and a movement of the printheads adapting to the shape of the glass. Inkjet printing is possible on a three-dimensional substrate.

The first embodiment (printing on the adhesive interlayer) and the second embodiment (printing on a curved glass sheet) are not mutually exclusive, rather, they can both be used on one laminated glazing.

Preferably, the laminated glazing comprises a light source, such as a light-emitting diode (LED), one of said two glass sheets or said adhesive interlayer constitutes a light guide optically coupled to the light source on the one hand, to the product of said digital printing which is able to extract the light thus guided on the other hand. The LED(s) may be in or near a (through) hole in the interior glass sheet for optical coupling through the wall delimiting the hole, or it/they may face the edge of the interior glass sheet.

When the organic ink of the method of the invention comprises luminescent particles, the laminated glazing preferably comprises a light source, such as a light-emitting diode (LED), emitting light of a wavelength at which the luminescent particles are excited and re-emit light in the visible region. This LED or these LEDs can be positioned as previously indicated. This excitation wavelength is for example in the UV in particular UVA, and potentially 365 at 400 or 390 nm. It is possible to consider LEDs emitting both at this excitation wavelength and in the visible.

In an advantageous embodiment, the laminated glazing has a low solar energy transmission (Total Solar Transmittance) in the visible and infrared regions. In other words, the amount of solar energy transmitted through the laminated glazing is low. For this purpose, in the case of a laminated glazing with two glass sheets whose faces are numbered from 1 to 4 from the outside in the mounting position, face 2 is provided with a stack of thin solar control layers (reflecting solar radiation), such as a silver multilayer, and/or face 4 with a low-emissivity coating based on tin-doped indium tin oxide (ITO), for example. A low-emissivity coating reflects infrared radiation back into a building or passenger compartment to keep it warm when the outside temperature is low.

Preferably, the laminated glazing comprises a functional film based on encapsulated liquid crystals or liquid crystals dispersed in a polymer matrix (PDLC), on electrophoretic particles dispersed in a medium, on particles dispersed in an electrophoretic fluid or a film of suspended particle device (SPD), or an electrochromic system.

Preferably, the one of said two glass sheets intended to be more outside the volume delimited by the laminated glazing is tinted, while the other of said two glass sheets, the interior one, is clear or extra-clear (in particular when it constitutes the light guide).

Another object of the invention is the use of a laminated glazing obtained by a manufacturing method described above, as a glazing for land, water or air vehicles, or as a glazing for buildings, in particular as a motor vehicle glazing, especially a motor vehicle roof.

The invention is now illustrated with the following examples.

### Counter-Example 1

An organic ink with a viscosity between 1 and 50 mPa·s is prepared by mixing
80% 4-Phenoxyethyl Monomer acrylate (PEA), UV-curable resin marketed by Sartomer (Arkema Group) under the commercial reference SR 410, viscosity at 25° C.=38 mPa·s,
16% polyvinyl butyral (PVB) at 10% in a 50/50 ethanol/Di(propylene glycol) methyl ether solvent, the PVB containing 30% dimethylcyclohexyl phthalate (plasticizer), and
4% 2-hydroxy-2-methyl-1-phenylpropanone (photoinitiator) marketed by Sartomer under the registered trademark Speedcure® 73.

All proportions are given by mass. The PVB is not successfully homogenized in solution.

### Example 1

Success is achieved this time by preparing a homogeneous organic ink of viscosity ranging between 1 and 50 mPa·s, by substituting for the UV curable resin of Counter—example 1, an identical proportion of UV-curable resin marketed by the company Sartomer (Arkema Group) under the commercial reference SR 238, viscosity at 25° C.=7 mPa·s; it is 1,6-Hexanediol Di Monomere acrylate (HDDA).

This ink is very homogeneous in solution. We observe a good quality of deposition on glass at 50 μm film thickness, as well as a good UV curing in one conveyor pass.

Into 99.8% of this ink, 0.2% of TiO₂ is mixed in scattering particles whose particle size satisfies the relationships 100 nm less than D90 less than 700 nm. A homogeneous white solution is obtained which is stable for several days at rest. Good quality of deposition on glass and PVB at 50 μm film thickness, good adhesion even on flexible PVB, good UV curing in one conveyor pass.

Optical evaluation of the transparency of a glass sheet coated with the transparent cross-linked ink, with and without TiO₂, particles, is performed using a Hazemeter model haze-gard plus 4725 with registered trademark BYK®. It checks for total transparency according to the methods of the international standard ASTM D1003-Standard Test Method for Haze and Luminous Transmittance of Transparent Plastics.

The table below shows the values of
TL: light transmission (Transmittance)
H: Haze
C: Clarity

TABLE 1

| Specimen | LT | H | C |
|---|---|---|---|
| Ink without TiO₂ | 91.9 | 0.53 | 99.7 |
| Ink with TiO₂ | 80.8 | 22.2 | 99.5 |

With TiO₂, a substrate with transparent designs is obtained that degrades light transmission and blur only to a very small extent, and maintains clarity almost unchanged, compared to the absence of TiO₂ particles. The use as automotive glazing, side window, rear window, glass roof, etc. is perfectly feasible in compliance with optical standards.

The designs formed with the TiO₂ particles are capable of extracting light from an LED bar at the edge of the glass, for example, the glass sheet or PVB layer constituting both the substrate and the light guide coupling the LED bar and the designs. By using scattering particles of various kinds, and/or light sources of various kinds, or even luminescent particles of various kinds, the invention makes it possible to obtain a glazing capable of lighting in several colors, simultaneously or sequentially.

### Counter-Example 2

10% PVB is mixed into 90% of the HDDA UV-curable resin used in Example 1. The PVB is not successfully homogenized in solution.

1. A method of making a laminated glazing comprising at least two glass sheets bonded to each other by an adhesive interlayer, the method comprising, prior to assembling the laminated glazing, digital printing of one face, intended to be inside the laminated glazing, of at least one of the two glass sheets after their possible forming/bending, and/or of at least one face of the adhesive interlayer, by a homogeneous organic ink with a viscosity between 1 and 50 mPa·s comprising 50 to 99% by weight of ultraviolet-curable resin and 0.05 to 20% by weight of scattering particles, and then curing the organic ink under illumination with ultraviolet radiation.

2. The method according to claim 1, wherein the adhesive interlayer is selected from polyvinyl butyral (PVB), thermoplastic polyurethane (TPU), an ethylene-vinyl acetate copolymer (EVA), or an ionomer.

3. The method according to claim 1, wherein the organic ink contains 0.01 to 20% by weight of one or more rheology modifiers.

4. The method according to claim 1, wherein the organic ink contains 0.1 to 20% by weight of 1 to 20% by weight of thermoplastic polymer material in one or more organic solvents.

5. The method according to claim 4, wherein the thermoplastic polymer material is selected from polyvinyl butyral (PVB), thermoplastic polyurethane (TPU), an ethylene-vinyl acetate copolymer (EVA), or an ionomer, alone or in a mixture or copolymer of several of them.

6. The method according to claim 4, wherein the thermoplastic polymer material contains 5 to 45% by weight of plasticizer.

7. The method according to claim 1, wherein the scattering particles have a particle size defined by D90 less than 2 μm.

8. The method according to claim 1, wherein the scattering particles are selected from non-luminescent TiO₂, SiO₂, CaCO₃, ZnO, Al₂O₃, ZrO₂ particles.

9. The method according to claim 1, wherein the organic ink comprises at most 5% by weight of luminescent particles, selected from luminophores, fast-decay fluorescent particles, or molecules coating non-luminescent particles.

10. The method according to claim 1, wherein the ultraviolet-curable resin is selected from a reaction product between a thiol and an alkene, an acrylate alone or as a mixture of two or more acrylates.

11. The method according to claim 1, wherein, prior to assembling the laminated glazing, the adhesive interlayer has a roughness Rz of between 5 and 25 μm.

12. The method according to claim 1, wherein the organic ink is printed directly onto the adhesive interlayer by single or multi-pass inkjet printing.

13. The method according to claim 1, wherein the organic ink is printed with printheads directly onto a curved glass sheet by single or multi-pass inkjet printing.

14. The method according to claim 13, wherein the printheads are mounted on a multi-axis robot and the one of the two glass sheets is fixed.

15. The method according to claim 13, wherein the one of the two glass sheets is curved, wherein the printheads are stationary printheads and wherein the curved one of the two glass sheets is held by a multi-axis robot under the stationary printheads.

16. The method according to claim 13, wherein there is both a movement of the one of the two glass sheets and a movement of the printheads adapting to a shape of the one of the two glass sheets.

17. The method according to claim 1, wherein the laminated glazing comprises a light source, wherein said one of said two glass sheets or said adhesive interlayer constitutes a light guide optically coupled to the light source, and to said digital printing which is able to extract the light thus guided.

18. The method according to claim 9, wherein the laminated glazing comprises a light source emitting light of a wavelength at which the luminescent particles are excited and re-emit light radiation in the visible region.

19. The method according to claim 1, wherein the laminated glazing has low solar energy transmission.

20. The method according to claim 1, wherein the laminated glazing comprises a functional film based on encapsulated liquid crystals or liquid crystals dispersed in a polymer matrix (PDLC), on electrophoretic particles dispersed in a medium, on particles dispersed in an electrophoretic fluid or a film of suspended particle device (SPD), or an electrochromic system.

21. The method according to claim 1, wherein the one of said two glass sheets intended to be more outside a volume delimited by the laminated glazing is tinted, while the other of said two glass sheets, the interior one, is clear or extra-clear.

22. A method comprising providing a laminated glazing obtained by a method of making according to claim 1, as glazing for a land, water or aerial vehicle, or as glazing for a building.
